(19) United States
(12) Patent Application Publication
(10) Pub. No.: US 2010/0182348 A1
(43) Pub. Date: Jul. 22, 2010

(54) Signal voltage generation circuit, display panel driving device, and display apparatus

(75) Inventor: Shigeki Okutani, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,799

(22) Filed: Jan. 5, 2010

(30) Foreign Application Priority Data
Jan. 16, 2009 (JP) 2009-007795

(51) Int. Cl. G09G 5/10; G09G 3/20

(52) U.S. Cl. 345/690; 345/55

(57) ABSTRACT

A voltage selection unit selects, based on a grayscale value represented by e.g. 10-bit grayscale data D<9:0>, two voltages Vb1 and Vb2 from among γ-correction voltages Va0, Va1, Va16, . . . , Va1008, Va1022, and Va1023 generated from one reference voltage. A divided voltage generation unit generates divided voltages Vc1-Vc16 by dividing a voltage difference between the Vb1 and Vb2 into 16 equal parts. The divided voltage generation unit makes a voltage value of the Vc1 that of the Va0 when the Va0 is selected, makes a voltage value of the Vc2 that of the Va1 when the Va1 is selected, makes a voltage value of the Vc15 that of the Va1022 when the Va1022 is selected, and makes a voltage value of the Vc16 that of the Va1023 when the Va1023 is selected. A DAC selects one divided voltage from among the Vc1-Vc16 based on lower-order four bits D<3:0>.

### BACKGROUND

1. Field of the Invention

The present invention relates to a signal voltage generation circuit, a display panel driving device, and a display apparatus, in particular to a technique to generate a signal voltage depending on an input grayscale.

2. Description of Related Art

A display panel such as an LCD (Liquid Crystal Display) has been widely adopted in the recent display apparatus. A driving device for such display panel is equipped with a signal voltage generation circuit that generates a signal voltage depending on an input grayscale (grayscale indicated by input display data). In this signal voltage generation circuit, γ-correction based on an optical characteristic of the display panel is performed.

For example, Japanese Unexamined Patent Application Publication No. 2007-248723 (hereinafter called “Hirashima”) discloses a signal voltage generation circuit composed of a power-supply selection circuit, a linear DAC (Digital to Analog Converter), and an output voltage selection circuit. The power-supply selection circuit selects two γ-correction voltages from among a plurality of γ-correction voltages based on the higher-order m bits of n-bit grayscale data. The linear DAC divides the voltage difference between the two γ-correction voltages selected by the power-supply selection circuit into equal parts with k-bit resolution (k=n−m), and outputs one of the divided voltages based on the lower-order k bits of the grayscale data. The output voltage selection circuit selects and outputs one voltage among the output voltage of the linear DAC and a plurality of externally-input voltages based on the grayscale data.

When the grayscale data represents a grayscale value near the minimum grayscale value or the maximum grayscale value, the above-mentioned output voltage selection circuit selects an externally-input voltage corresponding to that grayscale value. Otherwise, the output voltage selection circuit selects the output voltage of the linear DAC.

In this way, it is possible to cope with an actual γ curve (grayscale-voltage characteristic) that varies abruptly at both ends of the grayscale (in the vicinity of the minimum grayscale value and the maximum grayscale value).

### SUMMARY

However, the present inventor has found a problem that in the above-mentioned Hirashima, the signal voltage generation circuit requires a power supply (hereinafter called “external power supply”) for inputting the external voltages. In such a case, for example, the signal voltage generation circuit is provided with a number of terminals for receiving the external voltages. Therefore, the circuit scale (i.e., the size of the semiconductor package) could become larger.

An exemplary aspect the present invention is a signal voltage generation circuit including: a first voltage selection unit that selects, based on a grayscale value represented by n-bit grayscale data, two γ-correction voltages from among a plurality of γ-correction voltages generated from one reference voltage as γ-correction voltages for higher-order m bits of the grayscale data; a divided voltage generation unit that generates first to 2^{k}th divided voltages (k=n−m) by dividing a voltage difference between the selected two γ-correction voltages into 2^{k} equal parts; and a second voltage selection unit that selects one divided voltage from among the first to 2^{k}th divided voltages based on lower-order k bits of the grayscale data. The first voltage selection unit selects the two γ-correction voltages from among, at least, a γ-correction voltage corresponding to a grayscale value for every 2^{k} grayscale levels including a minimum grayscale value that is represented by the grayscale data, a first γ-correction voltage corresponding to a grayscale value larger than the minimum grayscale value by one, a γ-correction voltage corresponding to a maximum grayscale value that is represented by the grayscale data, and a second γ-correction voltage corresponding to a grayscale value smaller than the maximum grayscale value by one. The divided voltage generation unit makes a voltage value of the first divided voltage a voltage value of the γ-correction voltage corresponding to the minimum grayscale value when the γ-correction voltage corresponding to the minimum grayscale value is selected, makes a voltage value of the second divided voltage a voltage value of the first γ-correction voltage when the first γ-correction voltage is selected, makes a voltage value of the (2^{k}−1)th divided voltage a voltage value of the second γ-correction voltage when the second γ-correction voltage is selected, and makes a voltage value of the 2^{k}th divided voltage a voltage value of the γ-correction voltage corresponding to the maximum grayscale value when the γ-correction voltage corresponding to the minimum grayscale value is selected.

Further, another exemplary aspect of the present invention is a display panel driving device including: a data shaping circuit that shapes input data into n-bit grayscale data; a γ-correction voltage generation circuit that generates, at least, a γ-correction voltages corresponding to a grayscale value for every 2^{k} grayscale levels (k=n−m) including a minimum grayscale value that is represented by the grayscale data, a first γ-correction voltage corresponding to a grayscale value larger than the minimum grayscale value by one, a γ-correction voltage corresponding to a maximum grayscale value that is represented by the grayscale data, and a second γ-correction voltage corresponding to a grayscale value smaller than the maximum grayscale value by one from one reference voltage; and the above-mentioned signal voltage generation circuit.

Furthermore, another exemplary aspect the present invention is a display apparatus including the above-mentioned display panel driving device, and a display panel driven by this display panel driving device.

That is, in the present invention, it is possible to accurately generate a signal voltage depending on a grayscale near the minimum grayscale value or the maximum grayscale value by using only γ-correction voltages generated from one reference voltage. Therefore, the external power supply like the one used in the above-mentioned Hirashima is unnecessary.

According to the present invention, abrupt changes at both ends of a γ curve can be coped with without using any external power supply, so that increase in the scale of a signal voltage generation circuit, and a display panel driving device and a display apparatus applying the signal voltage generation circuit thereto can be prevented.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a configuration example of a display panel driving device and a display apparatus to which a signal voltage generation circuit according to first to third exemplary embodiments of the present invention is applied;

FIG. 2 is a block diagram showing a configuration example of a signal voltage generation circuit according to a first exemplary embodiment of the present invention;

FIG. 3 is a block diagram showing a configuration example of a switch control unit for use in a signal voltage generation circuit according to a first exemplary embodiment of the present invention;

FIG. 4 is a table showing an operation example of switches for use in a signal voltage generation circuit according to a first exemplary embodiment of the present invention;

FIG. 5 is a table showing an operation example of a first voltage selection unit for use in a signal voltage generation circuit according to a first exemplary embodiment of the present invention;

FIG. 6 is a block diagram showing an operation example in a case where grayscale data represents the minimum grayscale value in a signal voltage generation circuit according to a first exemplary embodiment of the present invention;

FIG. 7 is a table showing an operation example of a second voltage selection unit for use in a signal voltage generation circuit according to a first exemplary embodiment of the present invention;

FIG. 8 is a block diagram showing an operation example in a case where grayscale data represents a grayscale value near the minimum grayscale value in a signal voltage generation circuit according to a first exemplary embodiment of the present invention;

FIG. 9 is a block diagram showing an operation example in a case where grayscale data represents a grayscale value near the maximum grayscale value in a signal voltage generation circuit according to a first exemplary embodiment of the present invention;

FIG. 10 is a block diagram showing an operation example in a case where grayscale data represents the maximum grayscale value in a signal voltage generation circuit according to a first exemplary embodiment of the present invention;

FIG. 11A is a graph showing an output voltage characteristic in a signal voltage generation circuit according to a first exemplary embodiment of the present invention;

FIG. 11B is a graph showing an output voltage characteristic in a signal voltage generation circuit according to a first exemplary embodiment of the present invention;

FIG. 11C is a graph showing an output voltage characteristic in a signal voltage generation circuit according to a first exemplary embodiment of the present invention;

FIG. 12 is a block diagram showing a configuration example of a signal voltage generation circuit according to a second exemplary embodiment of the present invention;

FIG. 13 is a table showing an operation example of switches for use in a signal voltage generation circuit according to a second exemplary embodiment of the present invention;

FIG. 14 is a block diagram showing an operation example in a case where grayscale data represents a grayscale value near the minimum grayscale value in a signal voltage generation circuit according to a second exemplary embodiment of the present invention;

FIG. 15 is a block diagram showing an operation example in a case where grayscale data represents a grayscale value near the maximum grayscale value in a signal voltage generation circuit according to a second exemplary embodiment of the present invention;

FIG. 16A is a graph showing an output voltage characteristic in a signal voltage generation circuit according to a second exemplary embodiment of the present invention;

FIG. 16B is a graph showing an output voltage characteristic in a signal voltage generation circuit according to a second exemplary embodiment of the present invention;

FIG. 17 is a block diagram showing a configuration example of a signal voltage generation circuit according to a third exemplary embodiment of the present invention; and

FIG. 18 is a block diagram showing another configuration example of a signal voltage generation circuit according to a third exemplary embodiment of the present invention.

### DETAILED DESCRIPTION OF THE EXEMPLARY EMBODIMENTS

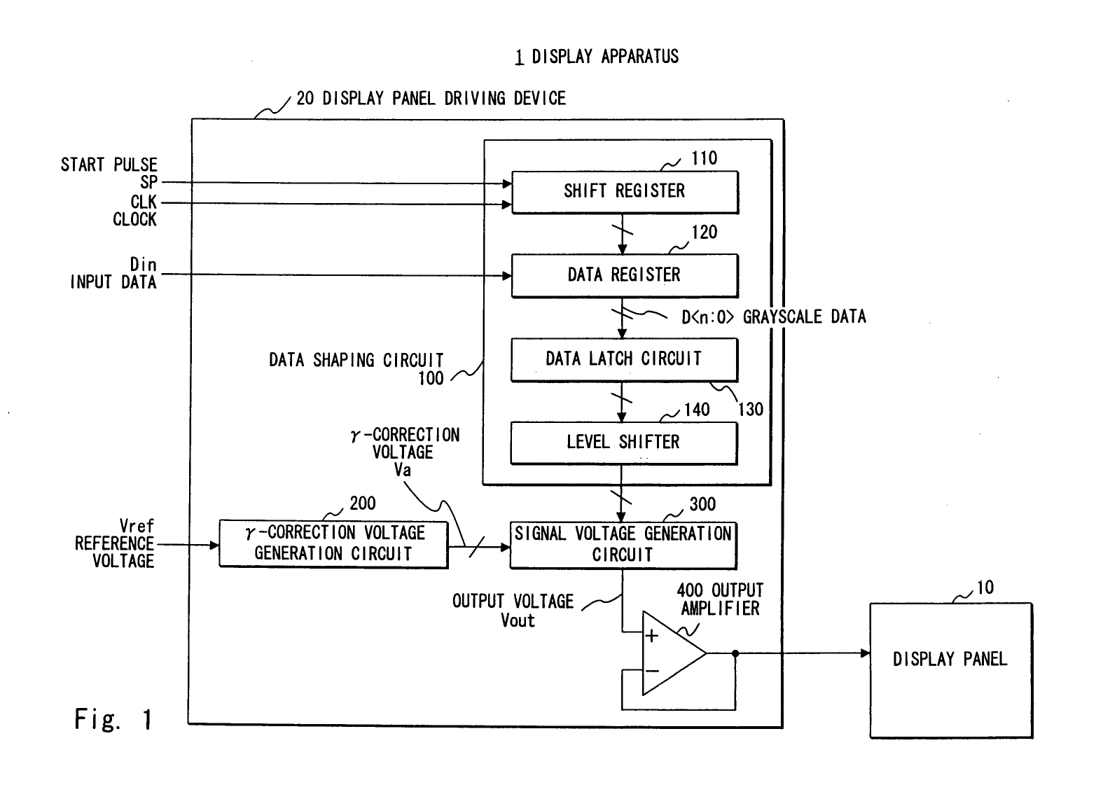

Hereinafter, configuration examples of signal voltage generation circuits according to first to third exemplary embodiments of the present invention, and a display panel driving device and a display apparatus to which these signal voltage generation circuits are applied will be explained with reference to FIGS. 1 to 18. Note that the same signs are assigned to the same elements throughout the drawings, and their duplicated explanation is omitted as appropriate for clarifying the explanation.

A display apparatus 1 shown in FIG. 1 includes, in general, a display panel 10 such as an LCD, and a display panel driving device 20 to drive the display panel 10. The display apparatus 1 may have a structure common to first to third exemplary embodiments.

Further, the display panel driving device 20 includes a data shaping circuit 100, a γ-correction voltage generation circuit 200, a signal voltage generation circuit 300, and an output amplifier 400. The data shaping circuit 100 shapes serial data Din input from a graphic card (not shown) or the like into n-bit grayscale data D<n:0>, and provides it to the signal voltage generation circuit 300. The γ-correction voltage generation circuit 200 generates a plurality of γ-correction voltages Va from a reference voltage Vref, and provides them to the signal voltage generation circuit 300. The signal voltage generation circuit 300 uses the γ-correction voltages Va to generate a signal voltage (hereinafter referred to as “output voltage”) Vout depending on a grayscale value represented by the grayscale data D<n:0>. The output amplifier 400, which forms a voltage follower circuit as shown in FIG. 1, performs an impedance conversion on the output voltage Vout from the signal voltage generation circuit 300, and provides to the display panel 10 the voltage on which the impedance conversion is performed. The display panel driving device 20 may have a structure common to first to third exemplary embodiments except for the number of the γ-correction voltages Va generated by the γ-correction voltage generation circuit 200 and the internal configuration of the signal voltage generation circuit 300.

Furthermore, the data shaping circuit 100 includes a shift register 110, a data register 120, a data latch circuit 130, and a level shifter 140. The shift register 110 shifts and outputs a start pulse SP at every rising or falling timing of a clock CLK. The data register 120 retains the data Din by one bit at a time whenever the start pulse SP is shifted and output from the shift register 110, thereby obtaining the grayscale data D<n:0>. The data latch circuit 130 latches the grayscale data D<n:0> retained in the data register 120, and provides it to the level shifter 140. The level shifter 140 converts the voltage level of the grayscale data D<n:0> to be provided to the signal voltage generation circuit 300.

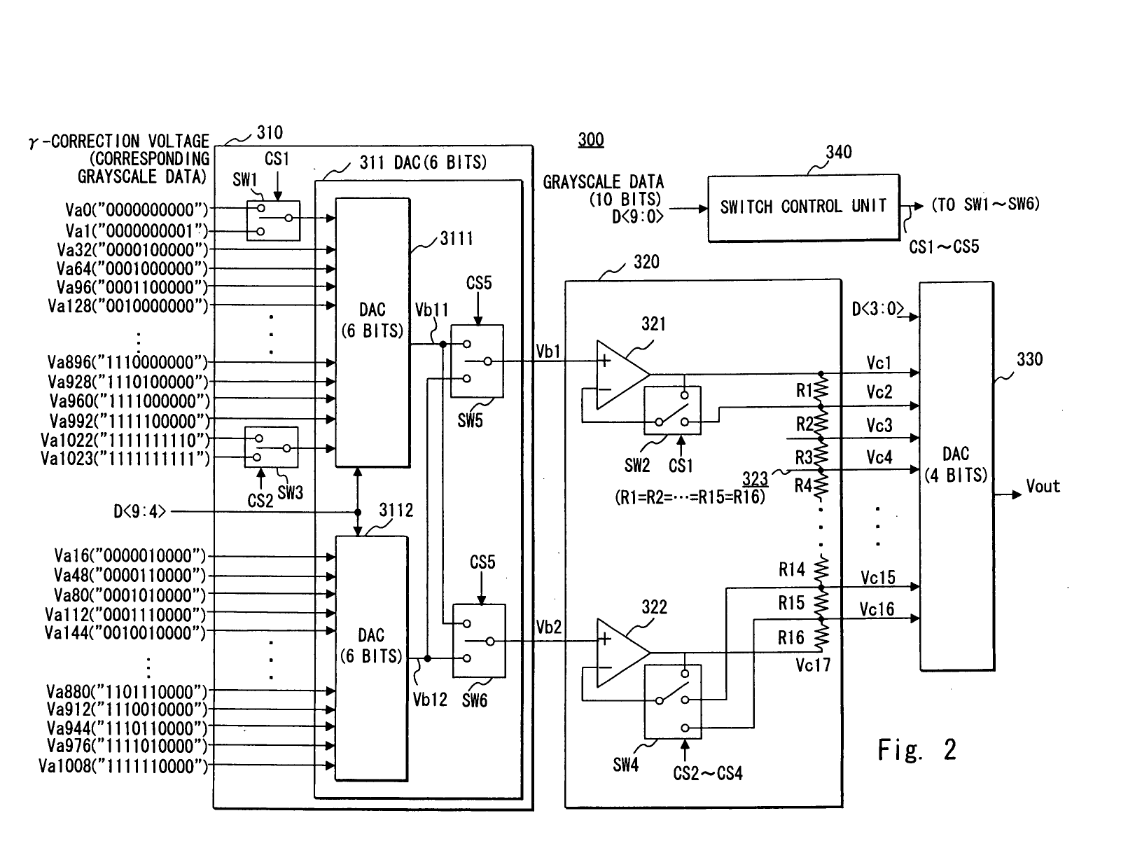

Hereinafter, first to third exemplary embodiments are explained one by one with reference to FIGS. 2 to 18.

### First Exemplary Embodiment

### Configuration Example

As shown in FIG. 2, a signal voltage generation circuit 300 according to this exemplary embodiment includes a voltage selection unit 310, a divided voltage generation unit 320, a DAC 330, and a switch control unit 340. The voltage selection unit 310 selects two γ-correction voltages (hereinafter referred to as “selected voltages”) Vb1 and Vb2 from among a plurality of γ-correction voltages Va based on, for example, higher-order 6 bits D<9:4> of 10-bit grayscale data D<9:0>. The divided voltage generation unit 320 generates divided voltages Vc1 to Vc16 by dividing a voltage difference between selected the voltages Vb1 and Vb2 output from the voltage selection unit 310 into 16 (2¹⁰⁻⁶) equal parts. The DAC 330 outputs one of the divided voltages Vc1 to Vc16 as the voltage Vout based on the lower-order 4 bits D<3:0> of the grayscale data D<9:0>. The switch control unit 340 generates control signals CS1 to CS5 for controlling switches SW1 to SW6, which are explained below, based on a grayscale value represented by the grayscale data D<9:0>. Note that the voltage selection unit 310 and the DAC 330 correspond to the above-described first and second voltage selection units respectively.

To the voltage selection unit 310, γ-correction voltages Va0, Va16, Va32, . . . , Va992 and Va1008 corresponding to grayscale values for every 16 grayscale levels including the minimum grayscale value (0 grayscale) “0000000000” that are represented by the grayscale data D<9:0>, a γ-correction voltage Va1 corresponding to 1 grayscale “0000000001”, a γ-correction voltage Va1022 corresponding to 1022 grayscale “1111111110”, and a γ-correction voltage Va1023 corresponding to the maximum grayscale value (1023 grayscale) “1111111111” are input from the γ-correction voltage generation circuit 200 shown in FIG. 1.

Further, the voltage selection unit 310 includes switches SW1 and SW3, and a DAC 311. The switch SW1 selects either of the γ-correction voltages Va0 and Va1 depending on the control signal CS1. The switch SW3 selects either of the γ-correction voltages Va1022 and Va1023 depending on the control signal CS2. The DAC 311 determines the selected voltages Vb1 and Vb2 from among the γ-correction voltages selected by the switches SW1 and SW3, and the γ-correction voltages Va16, Va32, . . . , Va992 and Va1008 based on the higher-order 6 bits D<9:4> of the grayscale data D<9:0>. The DAC 311 includes a DAC 3111, a DAC3112, and switches SW5 and SW6. The DAC 3111 selects one voltage Vb11 from among the γ-correction voltages selected by the switches SW1 and SW3, and γ-correction voltages Va32, Va64, . . . , Va960 and Va992 for every 32 grayscale levels based on the D<9:4>. The DAC 3112 selects one voltage Vb12 from among the γ-correction voltages Va16, Va48, . . . , Va976 and Va1008 for every 32 grayscale levels based on the D<9:4>. The switch SW5 outputs either of the selected voltages Vb11 and Vb12 as the selected voltage Vb1 depending on the control signal CS5. The switch SW6 outputs either of the selected voltages Vb11 and Vb12 as the selected voltage Vb2 depending on the control signal CS5.

Further, the divided voltage generation unit 320 includes operational amplifiers 321 and 322, a serial resistor array 323, and switches SW2 and SW4. The selected voltage Vb1 is input to the non-inverting input terminal of the operational amplifier 321. The selected voltage Vb2 is input to the non-inverting input terminal of the operational amplifier 322. The serial resistor array 323 is connected in series between the output terminals of the operational amplifiers 321 and 322, and is composed of resistors R1 to R16 having the same resistance value as each other. The switch SW2 connects either the output terminal of the operational amplifier 321 or the connection point between the resistors R1 and R2 to the inverting input terminal of the operational amplifier 321 depending on the control signal CS1. The switch SW4 connects one of the output terminal of the operational amplifier 322, the connection point between the resistors R15 and R16, and the connection point between the resistors R14 and R15 to the inverting input terminal of the operational amplifier 322 depending on the control signals CS2 to CS4. Note that the sign Vc17 in FIG. 2 is shown just to indicate a voltage generated at the output terminal of the operational amplifier 322 for the sake of convenience, and is not shown to indicate a divided voltage to be output to the DAC 330.

As described above, the voltage selection unit 310 and the divided voltage generation unit 320 can be simply constructed.

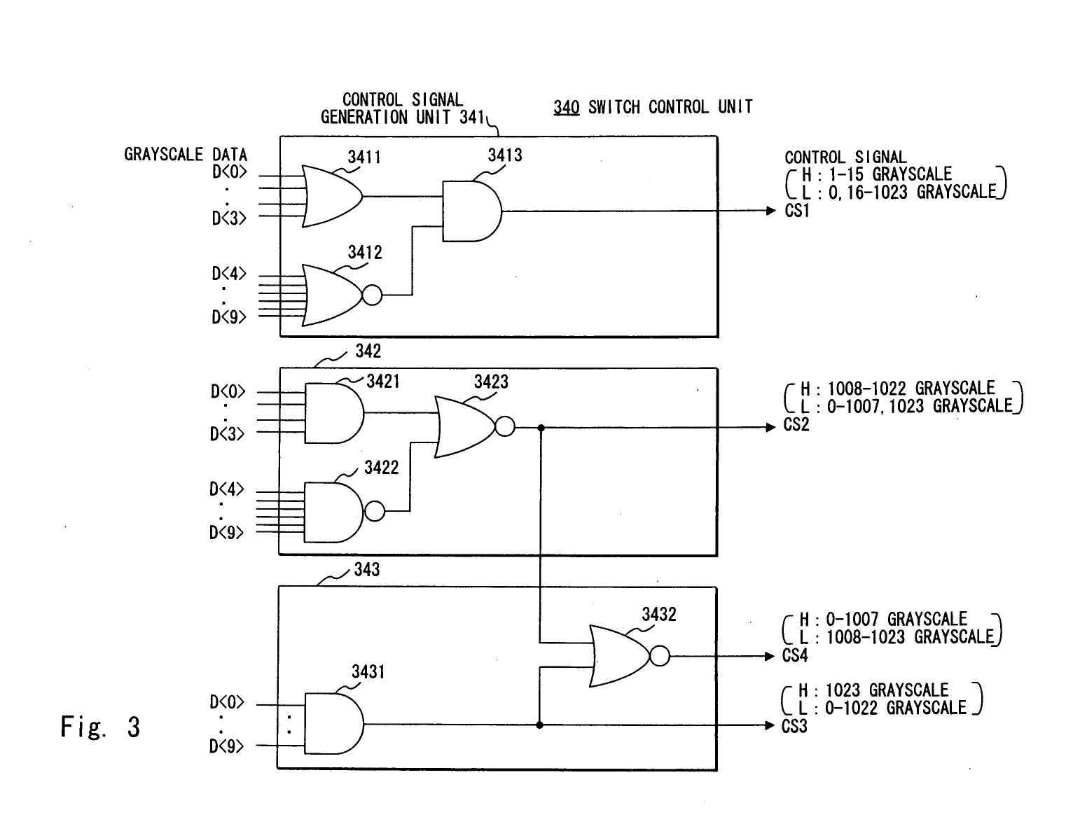

Further, as shown in FIG. 3, the switch control unit 340 includes control signal generation units 341, 342 and 343. The control signal generation unit 341 generates the control signal CS1 based on the grayscale data D<9:0>. The control signal generation unit 342 generates the control signal CS2 based on the grayscale data D<9:0>. The control signal generation unit 343 generates the control signals CS3 and CS4 based on the control signal CS2 and the grayscale data D<9:0>.

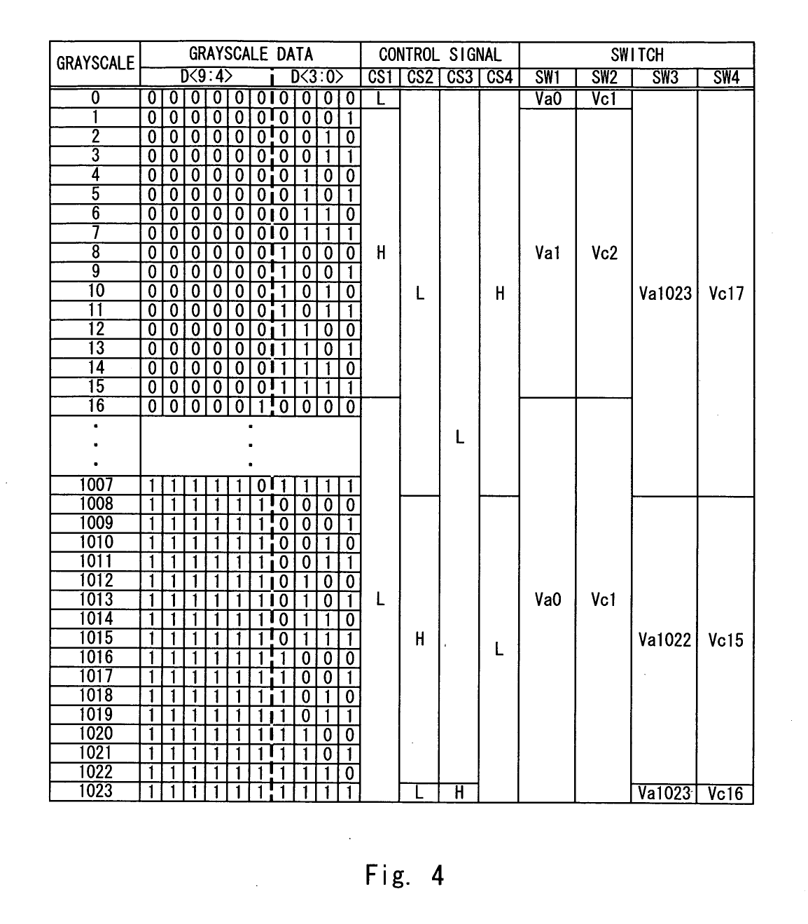

More specifically, the control signal generation unit 341 includes an OR circuit 3411, a NOR circuit 3412, and an AND circuit 3413. The lower-order 4 bits D<0> to D<3> of the data D<9:0> are input to the OR circuit 3411. The higher-order 6 bits D<4> to D<9> of the data D<9:0> are input to the NOR circuit 3412. The outputs of the OR circuit 3411 and the NOR circuit 3412 are input to the AND circuit 3413. Accordingly, as shown in FIG. 4, the control signal CS1 becomes a H (High) level only when the grayscale data D<9:0> represents 1 grayscale “0000000001” to 15 grayscale “0000001111”, and otherwise becomes a L (Low) level.

Further, the control signal generation unit 342 includes an AND circuit 3421, a NAND circuit 3422, and a NOR circuit 3423. The D<0> to D<3> are input to the AND circuit 3421. The D<4> to D<9> are input to the NAND circuit 3422. The outputs of the AND circuit 3421 and the NAND circuit 3422 are input to the NOR circuit 3423. Accordingly, as shown in FIG. 4, the control signal CS2 becomes a H level only when the grayscale data D<9:0> represents 1008 grayscale “1111110000” to 1022 grayscale “1111111110”, and otherwise becomes a L level.

Furthermore, the control signal generation unit 343 includes an AND circuit 3431, and a NOR circuit 3432. The D<0> to D<9> are input to the AND circuit 3431. The output of the AND circuit 3431 and the control signal CS2 are input to the NOR circuit 3432. The control signal generation unit 343 outputs the output of the AND circuit 3431 as the control signal CS3, and outputs the output of the NOR circuit 3432 as the control signal CS4. Accordingly, as shown in FIG. 4, the control signal CS3 becomes a H level only when the grayscale data D<9:0> represents 1023 grayscale “1111111111”, and otherwise becomes a L level. Meanwhile, the control signal CS4 becomes a L level only when the grayscale data D<9:0> represents 1008 grayscale “1111110000” to 1023 grayscale “1111111111”, and otherwise becomes a H level.

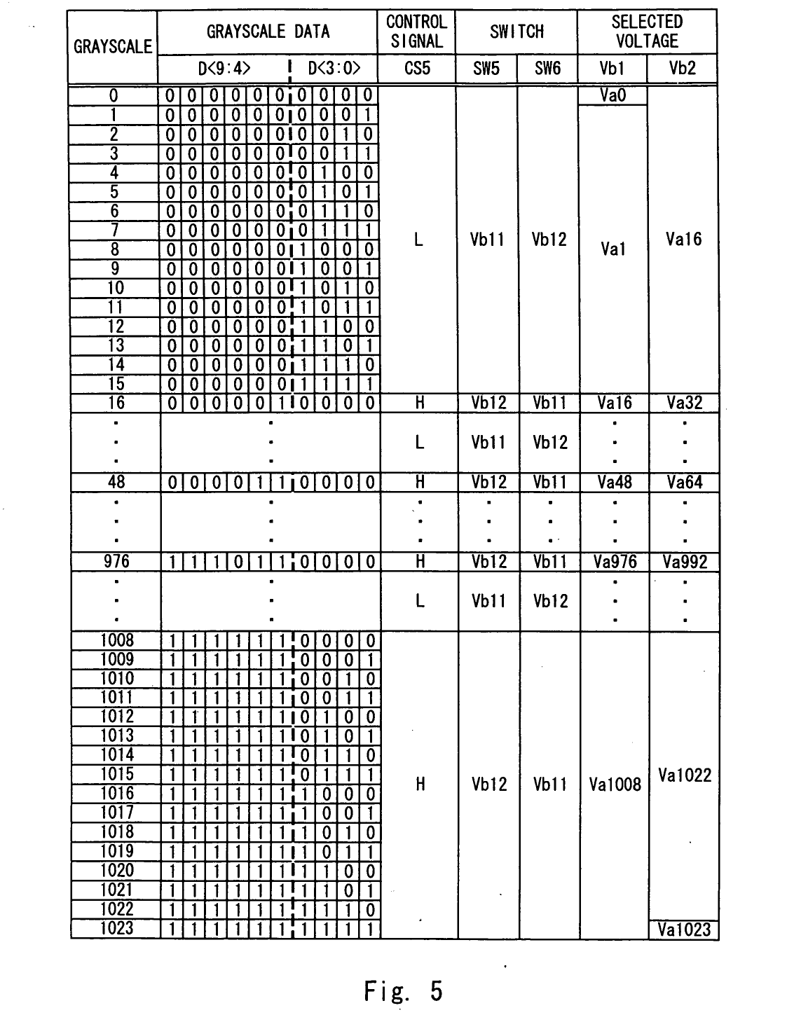

Further, although the illustration of the configuration of a generation unit for the control signal CS5 is omitted, an assumption is made, as shown in FIG. 5, that the control signal CS5 becomes a H level when the D<4>=“1” is satisfied, and becomes a L level when the D<4>=“0” is satisfied.

### Operation Example

Next, operations of this exemplary embodiment are explained in order of the following operation examples (1) to (5):
(1) An operation example in a case where the grayscale data D<9:0> represents 0 grayscale “0000000000”;
(2) An operation example in a case where the grayscale data D<9:0> represents 1 grayscale “0000000001” to 15 grayscale “0000001111”;
(3) An operation example in a case where the grayscale data D<9:0> represents 16 grayscale “0000010000” to 1007 grayscale “1111101111”;
(4) An operation example in a case where the grayscale data D<9:0> represents 1008 grayscale “1111110000” to 1022 grayscale “1111111110”; and
(5) An operation example in a case where the grayscale data D<9:0> represents 1023 grayscale “1111111111”.

### Operation Example (1)

When the grayscale data D<9:0> represents 0 grayscale “0000000000”, the control signal CS1 becomes the L level as shown in FIG. 4, so that it enters a state where the switch SW1 shown in FIG. 2 selects the γ-correction voltage Va0. At this point, the higher-order 6 bits D<9:4> of the D<9:0> are “000000”. Therefore, the DAC 3111 outputs the γ-correction voltage Va0 as the selected voltage Vb11, and the DAC 3112 outputs the γ-correction voltage Va16 as the selected voltage Vb12.

Further, when the control signal CS1 is at the L level, the switch SW2 in the divided voltage generation unit 320 connects the output terminal of the operational amplifier 321 (divided voltage Vc1) to its inverting input terminal. Meanwhile, when the control signals CS2 and CS3 are at the L level and the control signal CS4 is at the H level, the switch SW4 connects the output terminal of the operational amplifier 322 (divided voltage Vc17) to its inverting input terminal.

Furthermore, as shown in FIG. 5, the control signal CS5 becomes the L level. At this point, the switch SW5 selects the divided voltage Vb11, thereby outputting the selected voltage Vb1=γ-correction voltage Va0 to the operational amplifier 321. The switch SW6 selects the divided voltage Vb12, thereby outputting the selected voltage Vb2=γ-correction voltage Va16 to the operational amplifier 322.

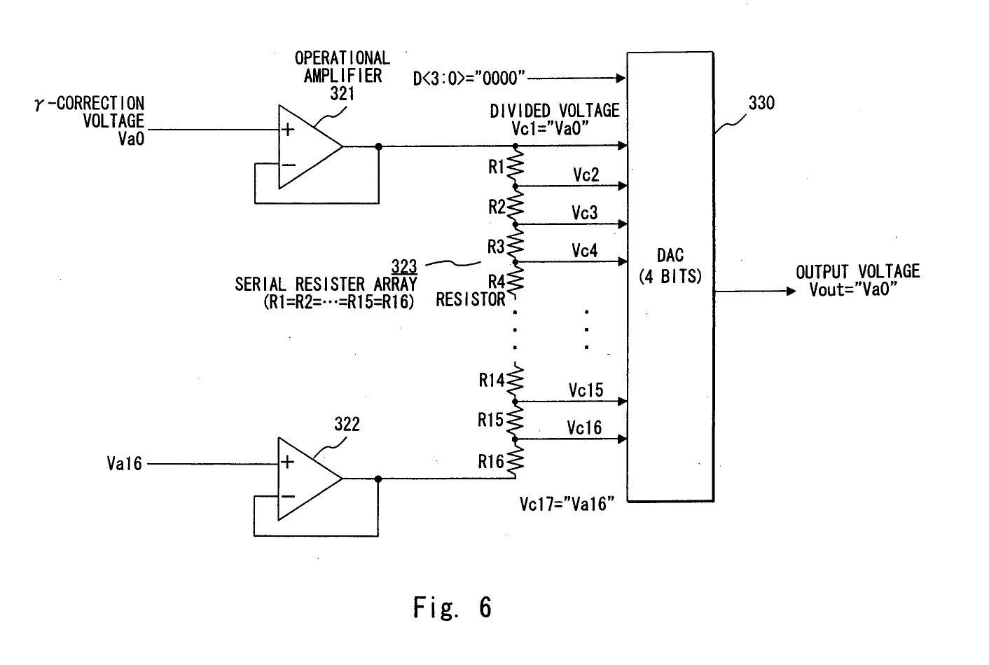

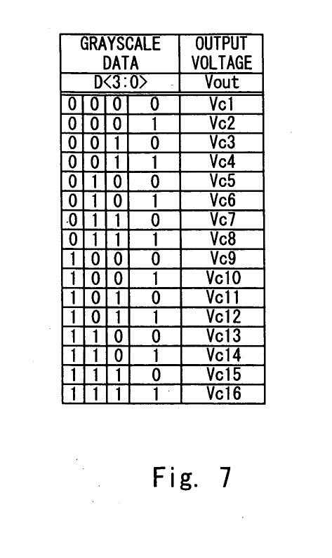

Accordingly, as shown in FIG. 6, the operational amplifier 321 forms a voltage follower circuit, and the divided voltage Vc1=γ-correction voltage Va0 is thereby input to the DAC 330. At this point, the lower-order 4 bits D<3:0> of the grayscale data D<9:0> indicate “0000”. Therefore, as shown in FIG. 7, the DAC 330 selects the divided voltage Vc1=γ-correction voltage Va0 as the output voltage Vout.

### Operation Example (2)

When the grayscale data D<9:0> represents 1 grayscale “0000000001” to 15 grayscale “0000001111”, the control signal CS1 becomes the H level as shown in FIG. 4, so that it enters a state where the switch SW1 shown in FIG. 2 selects the γ-correction voltage Val. At this point, the higher-order 6 bits D<9:4> of the D<9:0> are “000000”. Therefore, the DAC 3111 outputs the γ-correction voltage Va1 as the selected voltage Vb11, and the DAC 3112 outputs the γ-correction voltage Va16 as the selected voltage Vb12.

Further, when the control signal CS1 is at the H level, the switch SW2 in the divided voltage generation unit 320 connects the connection point between the resistors R1 and R2 (divided voltage Vc2) to the inverting input terminal of the operational amplifier 321. Meanwhile, since the control signals CS2 and CS3 are at the L level and the control signal CS4 is at the H level, the switch SW4 connects the output terminal of the operational amplifier 322 (divided voltage Vc17) to its inverting input terminal as in the case of the above-mentioned operation example (1).

Furthermore, as shown in FIG. 5, the control signal CS5 is at the L level. Therefore, the switch SW5 selects the voltage Vb11, thereby outputting the selected voltage Vb1=γ-correction voltage Va1 to the operational amplifier 321. The switch SW6 outputs the selected voltage Vb2=γ-correction voltage Va16 to the operational amplifier 322 as in the case of the above-mentioned operation example (1).

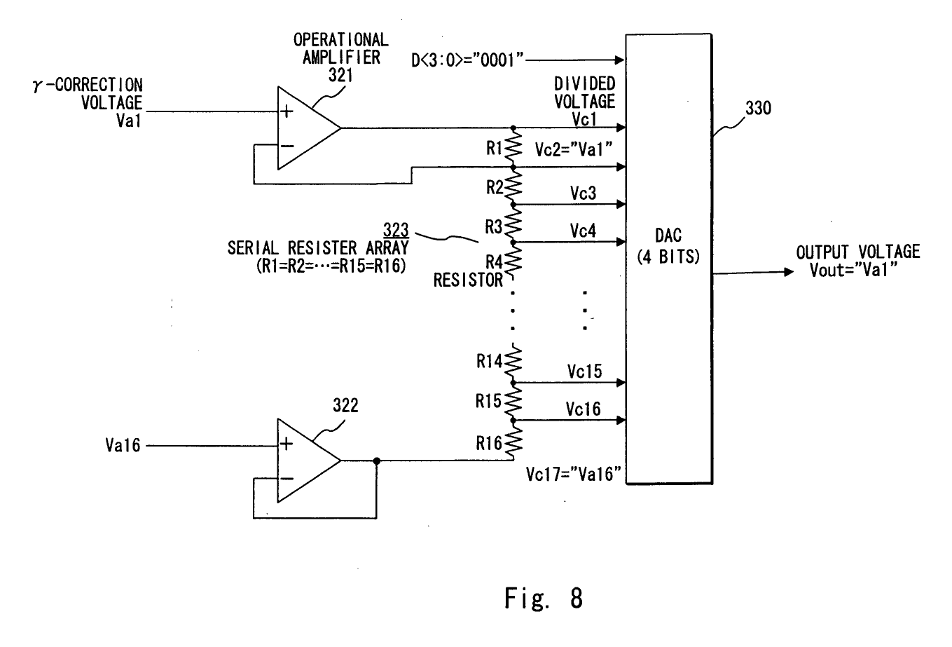

Accordingly, as shown in FIG. 8, the operational amplifier 321 forms a non-inverting amplifier circuit, and the divided voltage Vc2=γ-correction voltage Va1 is thereby input to the DAC 330. When the grayscale data D<9:0> represents 1 grayscale “0000000001”, the lower-order 4 bits D<3:0> indicate “0001”. Therefore, as shown in FIG. 7, the DAC 330 selects the divided voltage Vc2=γ-correction voltage Va1 as the output voltage Vout. Further, when the grayscale data D<9:0> represents 2 grayscale “0000000001” to 15 grayscale “0000001111”, the lower-order 4 bits. D<3:0> indicate “0010” to “1111”. Therefore, the DAC 330 outputs the divided voltages Vc3 to Vc16 respectively as the output voltage Vout.

### Operation Example (3)

When the grayscale data D<9:0> represents 16 grayscale “0000010000” to 1007 grayscale “1111101111”, the DAC 3111 outputs γ-correction voltages Va32, . . . , and Va992 respectively as the selected voltage Vb11, and the DAC 3112 outputs γ-correction voltages Va16, . . . , and Va 1008 respectively as the selected voltage Vb12.

Further, since the control signal CS1 is at the L level as shown in FIG. 4, the switch SW2 in the divided voltage generation unit 320 connects the output terminal of the operational amplifier 321 (divided voltage Vc1) to its inverting input terminal as in the case of the above-mentioned operation example (1). Meanwhile, since the control signals CS2 and CS3 are at the L level and the control signal CS4 is at the H level, the switch SW4 connects the output terminal of the operational amplifier 322 (divided voltage Vc17) to its inverting input terminal as in the case of the above-mentioned operation example (1).

Furthermore, the control signal CS5 becomes the H or L level depending on the value of D<4> of the grayscale data D<9:0>. Therefore, the DAC 311 outputs the γ-correction voltages Va16, Va32, . . . , and Va992 respectively as the selected voltage Vb1, and outputs the γ-correction voltages Va32, Va48, . . . , and Va1008 respectively as the selected voltage Vb2.

Accordingly, divided voltages Vc1 to Vc16 that are obtained by dividing each of the voltage differences between the γ-correction voltages Va16 to Va32, between the γ-correction voltages Va32 to Va48, . . . , and between the γ-correction voltages Va992 to Va1008 into 16 equal parts are output respectively as the voltage Vout from the signal voltage generation circuit 300.

### Operation Example (4)

When the grayscale data D<9:0> represents 1008 grayscale “1111110000” to 1022 grayscale “1111111110”, the control signal CS2 becomes the H level as shown in FIG. 4, so that it enters a state where the switch SW3 shown in FIG. 2 selects the γ-correction voltage Va1022.

At this point, the higher-order 6 bits D<9:4> of the D<9:0> are “111111”. Therefore, the DAC 3111 outputs the γ-correction voltage Va1022 as the selected voltage Vb11, and the DAC 3112 outputs the γ-correction voltage Va1008 as the selected voltage Vb12.

Further, since the control signal CS1 is at the L level, the switch SW2 in the divided voltage generation unit 320 connects the output terminal of the operational amplifier 321 (divided voltage Vc1) to its inverting input terminal as in the case of the above-mentioned operation examples (1) and (3). Meanwhile, since the control signals CS2 is at the H level and the control signals CS3 and CS4 are at the L level, the switch SW4 connects the connection point between the resistors R14 and R15 (divided voltage Vc15) to the inverting input terminal of the operational amplifier 322 in contrast to the above-mentioned operation examples (1) to (3).

Furthermore, as shown in FIG. 5, the control signal CS5 is at the H level. Therefore, the switch SW5 selects the voltage Vb12, thereby outputting the selected voltage Vb1=γ-correction voltage Va1008 to the operational amplifier 321. The switch SW6 selects the voltage Vb11, thereby outputting the selected voltage Vb2=γ-correction voltage Va1022 to the operational amplifier 322.

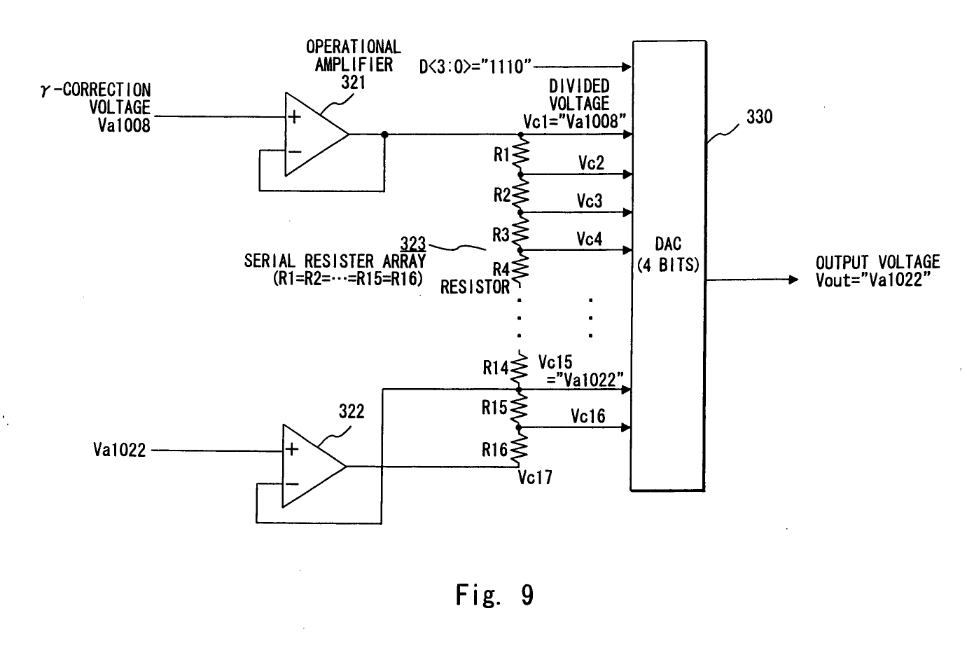

Accordingly, as shown in FIG. 9, the operational amplifier 322 forms a non-inverting amplifier circuit, and the divided voltage Vc15 =γ-correction voltage Va1022 is thereby input to the DAC 330. When the grayscale data D<9:0> represents 1022 grayscale “1111111110”, the lower-order 4 bits D<3:0> indicate “1110”. Therefore, as shown in FIG. 7, the DAC 330 selects the divided voltage Vc15 =γ-correction voltage Va1022 as the output voltage Vout. Further, when the grayscale data D<9:0> represents 1008 grayscale “1111110000” to 1021 grayscale “1111111101”, the lower-order 4 bits D<3:0> indicate “0000” to “1101”. Therefore, the DAC 330 outputs the divided voltages Vc1 to Vc14 respectively as the output voltage Vout.

### Operation Example (5)

When the grayscale data D<9:0> represents 1023 grayscale “1111111111”, the control signal CS2 becomes the L level as shown in FIG. 4, so that it enters a state where the switch SW3 shown in FIG. 2 selects the γ-correction voltage Va1023. At this point, since the higher-order 6 bits D<9:4> of the D<9:0> are “111111”, the DAC 3111 outputs the γ-correction voltage Va1023 as the selected voltage Vb11, and the DAC 3112 outputs the γ-correction voltage Va1008 as the selected voltage Vb12.

Further, since the control signal CS1 is at the L level, the switch SW2 in the divided voltage generation unit 320 connects the output terminal of the operational amplifier 321 (divided voltage Vc1) to its inverting input terminal as in the case of the above-mentioned operation examples (1), (3) and (4). Meanwhile, since the control signals CS3 is at the H level and the control signals CS2 and CS4 are at the L level, the switch SW4 connects the connection point between the resistors R15 and R16 (divided voltage Vc16) to the inverting input terminal of the operational amplifier 322 in contrast to the above-mentioned operation examples (1) to (4).

Furthermore, as shown in FIG. 5, the control signal CS5 is at the H level. Therefore, the switch SW5 selects the voltage Vb12, thereby outputting the selected voltage Vb1=γ-correction voltage Va1008 to the operational amplifier 321. The switch SW6 selects the voltage Vb11, thereby outputting the selected voltage Vb2=γ-correction voltage Va1023 to the operational amplifier 322.

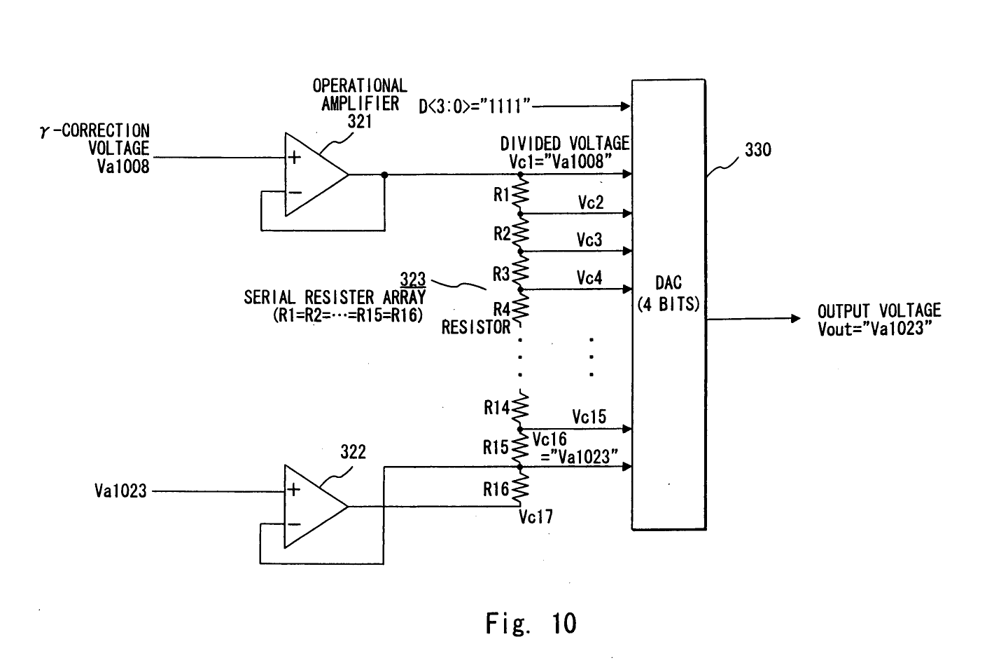

Accordingly, as shown in FIG. 10, the operational amplifier 322 forms a non-inverting amplifier circuit, and the divided voltage Vc16=γ-correction voltage Va1023 is thereby input to the DAC 330. When the grayscale data D<9:0> represents 1023 grayscale “1111111111”, the lower-order 4 bits D<3:0> indicate “1111”. Therefore, as shown in FIG. 7, the DAC 330 selects the divided voltage Vc16=γ-correction voltage Va1023 as the output voltage Vout.

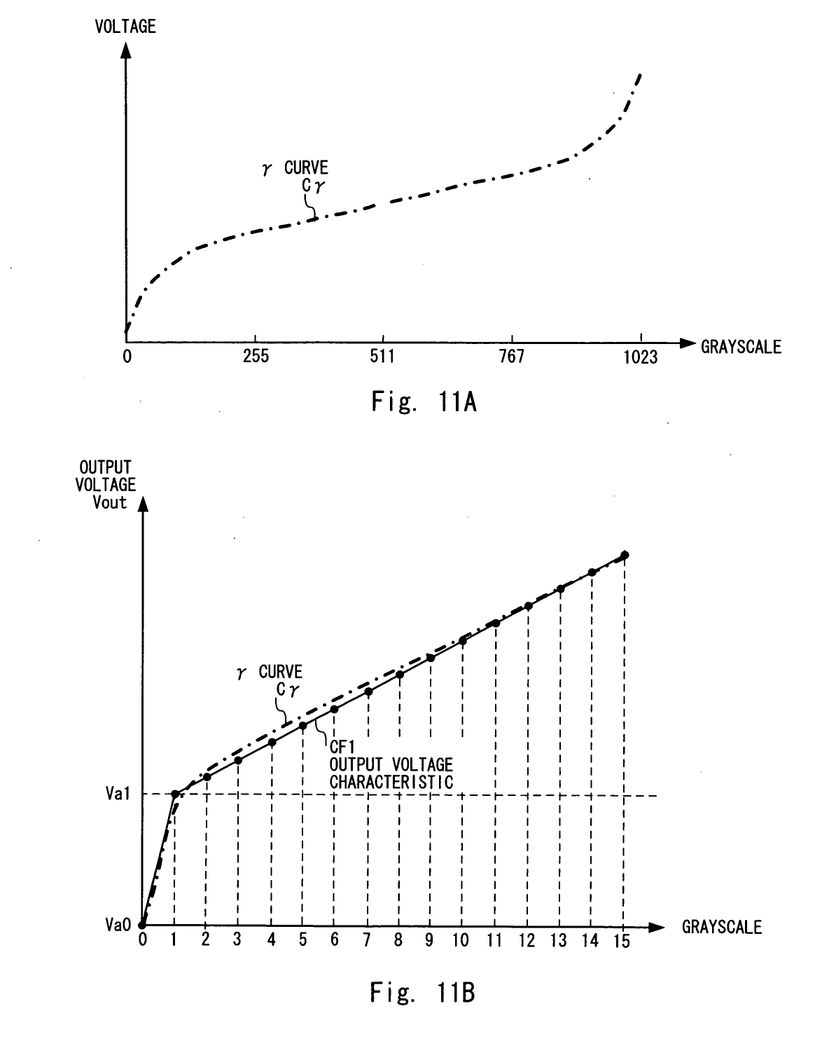

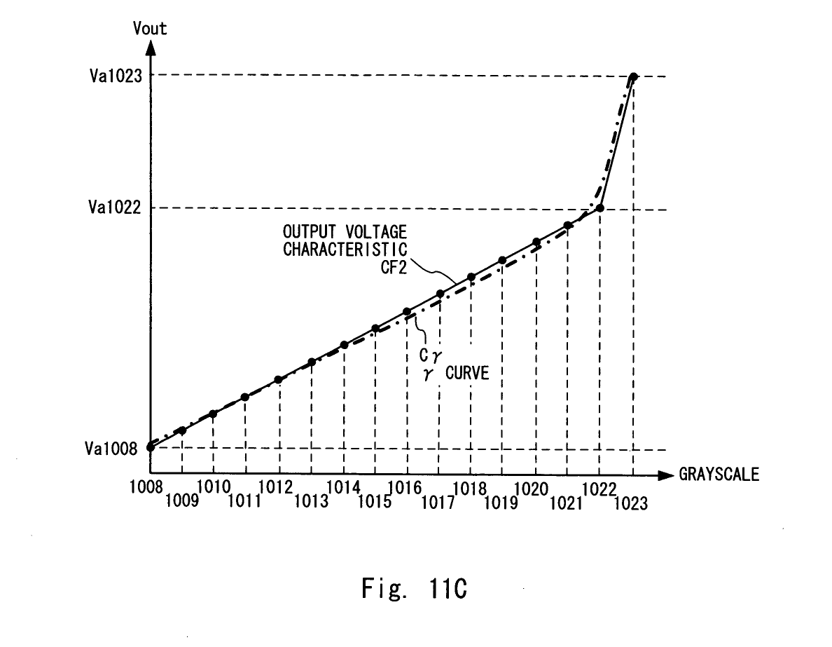

In accordance with the operation examples (1) to (5) explained above, abrupt changes at both ends of a γ curve can be coped with without using any external power supply shown in above-mentioned Hirashima. More specifically, even in a case where a γ curve Cγ shown in FIG. 11A varies abruptly at 1 grayscale and 1022 grayscale as shown as alternate long and short dash lines in FIGS. 11B and 11C, the signal voltage generation circuit 300 can obtain output voltage characteristics CF1 and CF2 close to the γ curve Cγ.

### Second Exemplary Embodiment

### Configuration Example

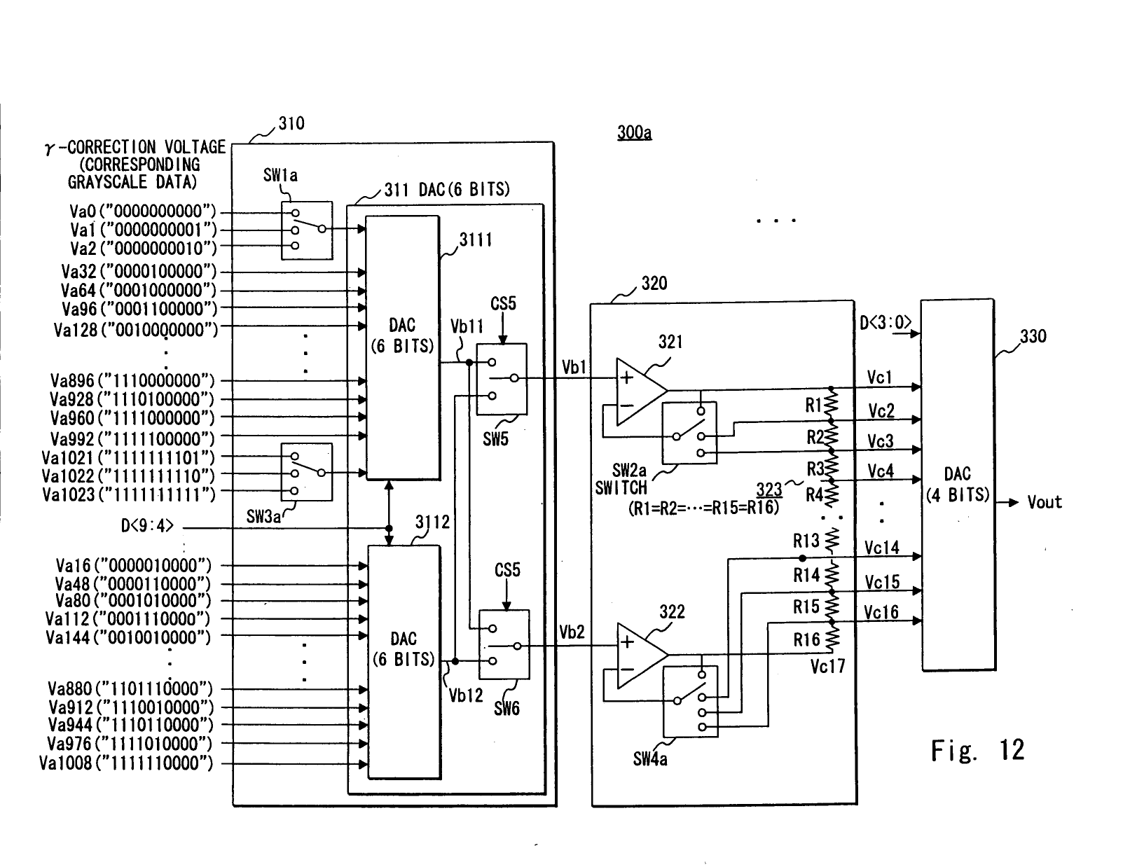

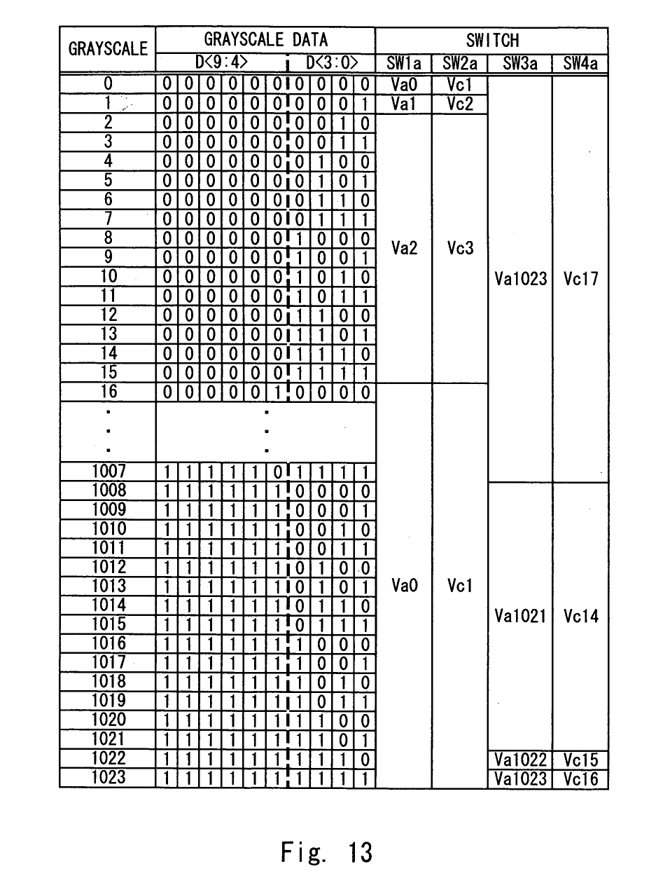

As shown in FIG. 12, a signal voltage generation circuit 300a according to this exemplary embodiment is different from the signal voltage generation circuit 300 shown in FIG. 2 according to the above-mentioned first exemplary embodiment in the following points (A) to (E).
(A) γ-correction voltages Va2 and Va1021 corresponding to 2 grayscale “0000000010” and 1021 grayscale “1111111101” respectively that are represented by the grayscale data D<9:0> are input in addition to the γ-correction voltages Va0, Va1, Va16, . . . , Va1008, Va1022 and Va1023 shown in FIG. 2.
(B) A switch SW1a that selects one of the γ-correction voltages Va0 to Va2 is provided in place of the switch SW1 shown in FIG. 2.
(C) A switch SW2a that selects one of the output terminal of the operational amplifier 321, the connection point between the resistors R1 and R2, and the connection point between the resistors R2 and R3 is provided in place of the switch SW2 shown in FIG. 2.
(D) A switch SW3a that selects one of the γ-correction voltages Va1021 to Va1023 is provided in place of the switch SW3 shown in FIG. 2.
(E) A switch SW4a that selects one of the output terminal of the operational amplifier 322, the connection point between the resistors R15 and R16, the connection point between the resistors R14 and R15, and the connection point between the resistors R13 and R14 is provided in place of the switch SW4 shown in FIG. 2.

Further, the above-mentioned switches SW1a to SW4a operate depending on control signals that are supplied from a switch control unit (not shown) based on the grayscale data D<9:0>.

### Operation Example

Next, operations of this exemplary embodiment are explained in order of the following operation examples (1) to (7):
(1) An operation example in a case where the grayscale data D<9:0> represents 0 grayscale “0000000000”;
(2) An operation example in a case where the grayscale data D<9:0> represents 1 grayscale “0000000001”;
(3) An operation example in a case where the grayscale data D<9:0> represents 2 grayscale “0000000010” to 15 grayscale “0000001111”;
(4) An operation example in a case where the grayscale data D<9:0> represents 16 grayscale “0000010000” to 1007 grayscale “1111101111”;
(5) An operation example in a case where the grayscale data D<9:0> represents 1008 grayscale “1111110000” to 1021 grayscale “1111111101”;
(6) An operation example in a case where the grayscale data D<9:0> represents 1022 grayscale “1111111110”; and
(7) An operation example in a case where the grayscale data D<9:0> represents 1023 grayscale “1111111111”.

### Operation Example (1)

When the grayscale data D<9:0> represents 0 grayscale “0000000000”, the switch SW1a selects the γ-correction voltage Va0 as shown in FIG. 13. At this point, the higher-order 6 bits D<9:4> of the D<9:0> are “000000”. Therefore, the DAC 311 outputs the selected voltage Vb1=γ-correction voltage Va0 to the operational amplifier 321, and outputs the selected voltage Vb2=γ-correction voltage Va16 to the operational amplifier 322 as in the case of the above-mentioned first exemplary embodiment.

Further, the switch SW2a connects the output terminal of the operational amplifier 321 (divided voltage Vc1) to its inverting input terminal. Meanwhile, the switch SW4a connects the output terminal of the operational amplifier 322 (divided voltage Vc17) to its inverting input terminal.

Accordingly, the divided voltage Vc1=γ-correction voltage Va0 is input to the DAC 330 as in the case of FIG. 6. At this point, the DAC 330 selects the divided voltage Vc1=γ-correction voltage Va0 as the output voltage Vout.

### Operation Example (2)

When the grayscale data D<9:0> represents 1 grayscale “0000000001”, the switch SW1a selects the γ-correction voltage Va1 as shown in FIG. 13. At this point, the higher-order 6 bits D<9:4> of the D<9:0> are “000000”. Therefore, the DAC 311 outputs the selected voltage Vb1=γ-correction voltage Va1 to the operational amplifier 321, and outputs the selected voltage Vb2=γ-correction voltage Va16 to the operational amplifier 322 as in the case of the above-mentioned first exemplary embodiment.

Further, the switch SW2a connects the connection point between the resistors R1 and R2 (divided voltage Vc2) to the inverting input terminal of the operational amplifier 321. Meanwhile, the switch SW4a connects the output terminal of the operational amplifier 322 (divided voltage Vc17) to its inverting input terminal.

Accordingly, the divided voltage Vc2=γ-correction voltage Va1 is input to the DAC 330 as in the case of FIG. 8. At this point, the DAC 330 selects the divided voltage Vc2=γ-correction voltage Va1 as the output voltage Vout.

### Operation Example (3)

When the grayscale data D<9:0> represents 2 grayscale “0000000010” to 15 grayscale “0000001111”, the switch SW selects the γ-correction voltage Va2 as shown in FIG. 13. At this point, the higher-order 6 bits D<9:4> of the D<9:0> are “000000”. Therefore, the DAC 311 outputs the selected voltage Vb1=γ-correction voltage Va2 to the operational amplifier 321, and outputs the selected voltage Vb2=γ-correction voltage Va16 to the operational amplifier 322.

Further, the switch SW2a connects the connection point between the resistors R2 and R3 (divided voltage Vc3) to the inverting input terminal of the operational amplifier 321. Meanwhile, the switch SW4a connects the output terminal of the operational amplifier 322 (divided voltage Vc17) to its inverting input terminal.

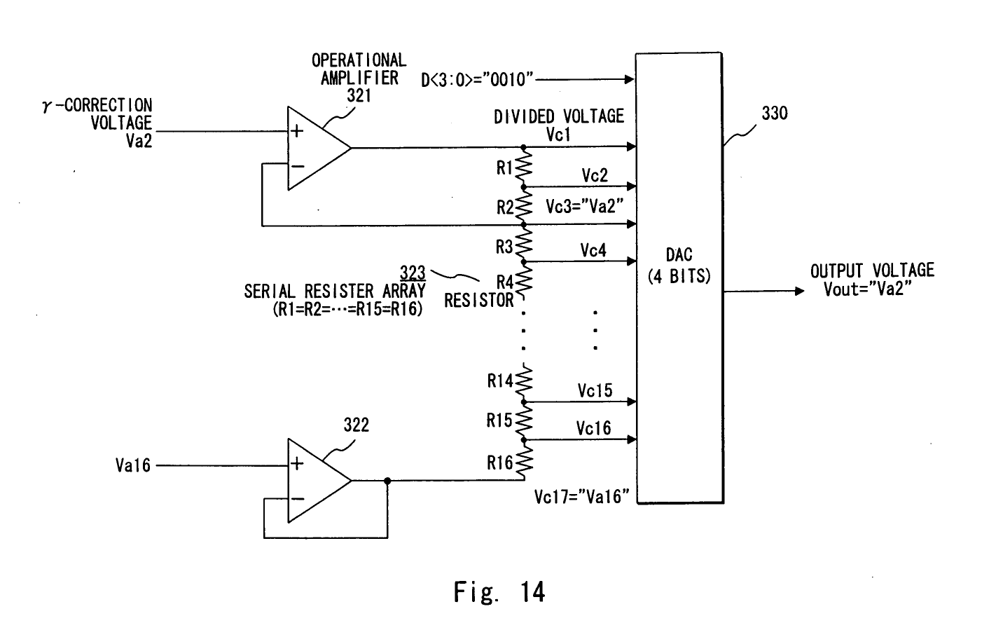

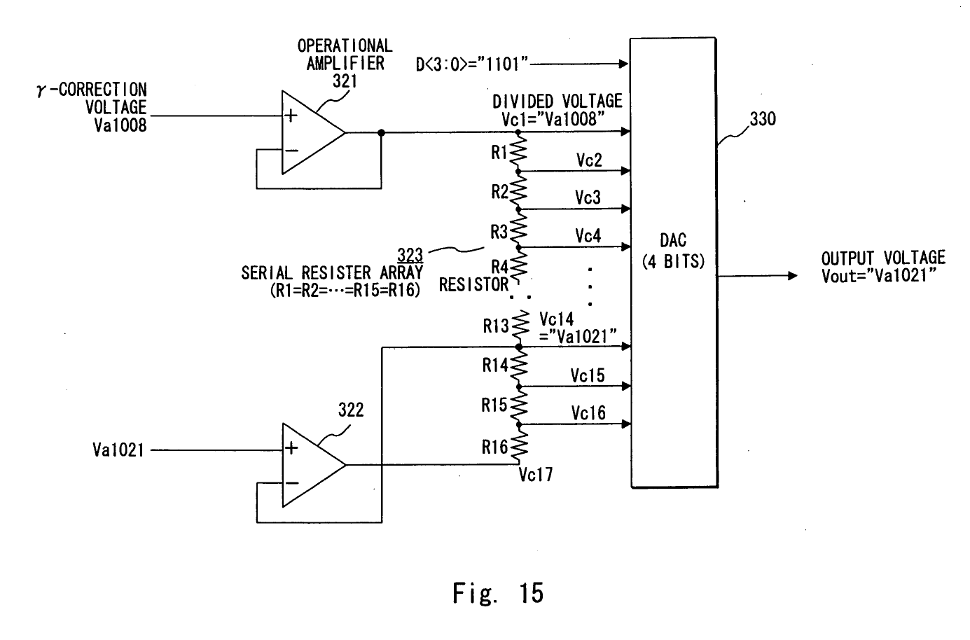

Accordingly, as shown in FIG. 14, the operational amplifier 321 forms a non-inverting amplifier circuit, and the divided voltage Vc3=γ-correction voltage Va2 is thereby input to the DAC 330. When the grayscale data D<9:0> represents 2 grayscale “0000000010”, the lower-order 4 bits D<3:0> indicate “0010”. Therefore, the DAC 330 selects the divided voltage Vc3=γ-correction voltage Va2 as the output voltage Vout. Further, when the grayscale data D<9:0> represents 3 grayscale “0000000011” to 15 grayscale “0000001111”, the lower-order 4 bits D<3:0> indicate “0011” to “1111”. Therefore, the DAC 330 outputs the divided voltages Vc4 to Vc16 respectively as the output voltage Vout.

### Operation Example (4)

When the grayscale data D<9:0> represents 16 grayscale “0000010000” to 1007 grayscale “1111101111”, the DAC 311 outputs γ-correction voltages Va16, Va32, . . . , and Va992 respectively as the selected voltage Vb1, and outputs γ-correction voltages Va32, Va48, . . . , and Va1008 respectively as the selected voltage Vb2 as in the case of the above-mentioned first exemplary embodiment.

Further, as shown in FIG. 13, the switch SW2a connects the output terminal of the operational amplifier 321 (divided voltage Vc1) to its inverting input terminal. Meanwhile, the switch SW4a connects the output terminal of the operational amplifier 322 (divided voltage Vc17) to its inverting input terminal.

Accordingly, divided voltages Vc1 to Vc16 that are obtained by dividing each of the voltage difference between the γ-correction voltages Va16 to Va32, between the γ-correction voltages Va32 to Va48, . . . , and between the γ-correction voltages Va992 to Va1008 into 16 equal parts are output respectively as the voltage Vout from the signal voltage generation circuit 300a.

### Operation Example (5)

When the grayscale data D<9:0> represents 1008 grayscale “1111110000” to 1021 grayscale “1111111101”, the switch SW3a selects the γ-correction voltage Va1021 as shown in FIG. 13. At this point, the higher-order 6 bits D<9:4> of the D<9:0> are “111111”. Therefore, the DAC 311 outputs the selected voltage Vb1=γ-correction voltage Va1008 to the operational amplifier 321, and outputs the selected voltage Vb2=γ-correction voltage Va1021 to the operational amplifier 322.

Further, the switch SW2a connects the output terminal of the operational amplifier 321 (divided voltage Vc1) to its inverting input terminal. Meanwhile, the switch SW4a connects the connection point between the resistors R13 and R14 (divided voltage Vc14) to the inverting input terminal of the operational amplifier 322.

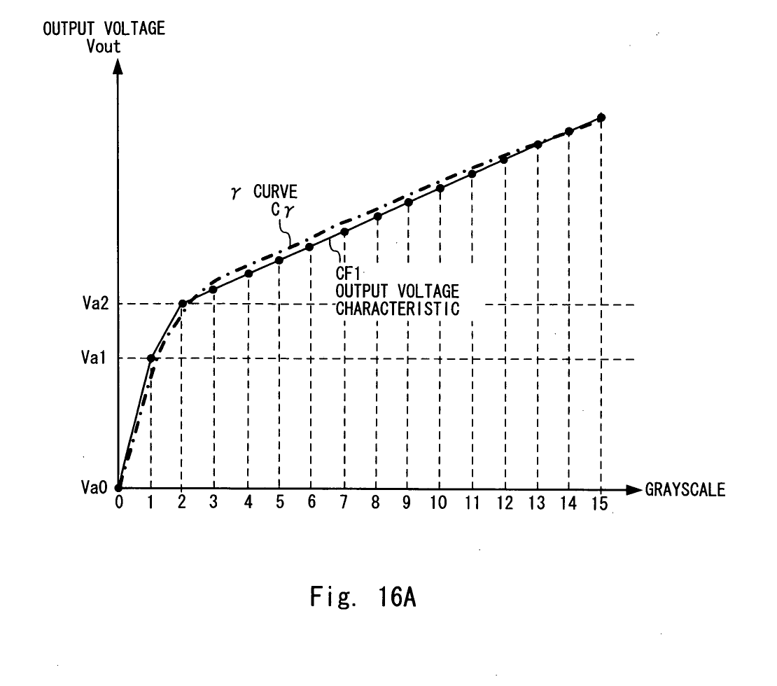

Accordingly, as shown in FIG. 15, the operational amplifier 322 forms a non-inverting amplifier circuit, and the divided voltage Vc14=γ-correction voltage Va1021 is thereby input to the DAC 330. When the grayscale data D<9:0> represents 1021 grayscale “1111111101”, the lower-order 4 bits D<3:0> indicate “1101”. Therefore, the DAC 330 selects the divided voltage Vc14=γ-correction voltage Va1021 as the output voltage Vout. Further, when the grayscale data D<9:0> represents 1008 grayscale “1111110000” to 1020 grayscale “1111111100”, the lower-order 4 bits D<3:0> indicate “0000” to “1100”. Therefore, the DAC 330 outputs the divided voltages Vc1 to Vc13 respectively as the output voltage Vout.

### Operation example (6)

When the grayscale data D<9:0> represents 1022 grayscale “1111111110”, the switch SW3a selects the γ-correction voltage Va1022 as shown in FIG. 13. At this point, the higher-order 6 bits D<9:4> of the D<9:0> are “111111”. Therefore, the DAC 311 outputs the selected voltage Vb1=γ-correction voltage Va1008 to the operational amplifier 321, and outputs the selected voltage Vb2=γ-correction voltage Va1022 to the operational amplifier 322.

Further, the switch SW2a connects the output terminal of the operational amplifier 321 (divided voltage Vc1) to its inverting input terminal. Meanwhile, the switch SW4a connects the connection point between the resistors R14 and R15 (divided voltage Vc15) to the inverting input terminal of the operational amplifier 322.

Accordingly, the divided voltage Vc15=γ-correction voltage Va1022 is input to the DAC 330 as in the case of FIG. 9. At this point, the DAC 330 selects the divided voltage Vc15=γ-correction voltage Va1022 as the output voltage Vout.

### Operation Example (7)

When the grayscale data D<9:0> represents 1023 grayscale “1111111111”, the switch SW3a selects the γ-correction voltage Va1023 as shown in FIG. 13. At this point, the higher-order 6 bits D<9:4> of the D<9:0> are “111111”. Therefore, the DAC 311 outputs the selected voltage Vb1=γ-correction voltage Va1008 to the operational amplifier 321, and outputs the selected voltage Vb2=γ-correction voltage Va1023 to the operational amplifier 322.

Further, the switch SW2a connects the output terminal of the operational amplifier 321 (divided voltage Vc1) to its inverting input terminal. Meanwhile, the switch SW4a connects the connection point between the resistors R15 and R16 (divided voltage Vc16) to the inverting input terminal of the operational amplifier 322.

Accordingly, the divided voltage Vc16=γ-correction voltage Va1023 is input to the DAC 330 as in the case of FIG. 10. At this point, the DAC 330 selects the divided voltage Vc16=γ-correction voltage Va1023 as the output voltage Vout.

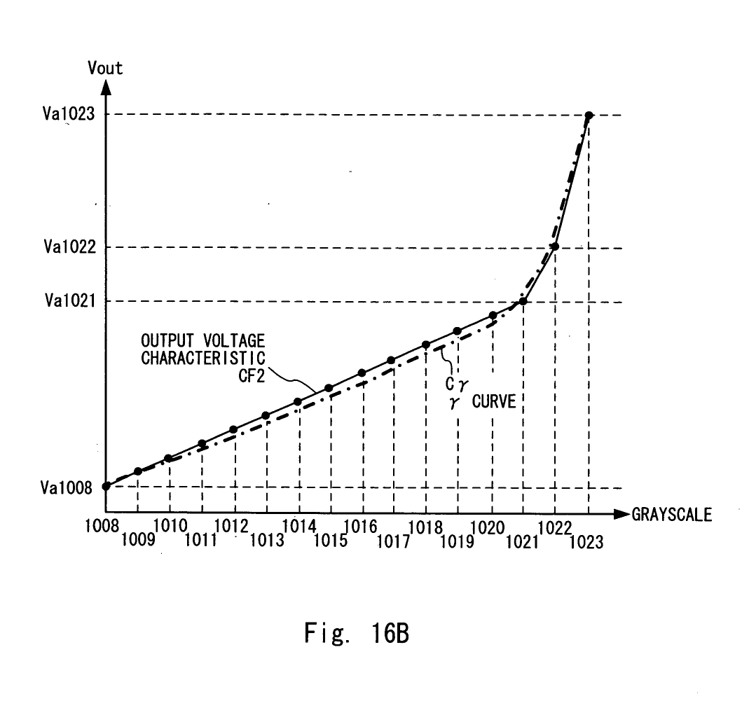

In accordance with the operation examples (1) to (7) explained above, even in a case where a γ curve Cγ varies abruptly at 1 grayscale and 2 grayscale as shown as an alternate long and short dash line in FIG. 16A and varies abruptly at 1021 grayscale and 1022 grayscale as shown as an alternate long and short dash line in FIG. 16B, the signal voltage generation circuit 300a can obtain output voltage characteristics CF1 and CF2 close to the γ curve Cγ.

Further, the output voltage characteristics can be brought closer to the γ curve by increasing the number of inputs of the γ-correction voltages corresponding to grayscale levels near the 0 grayscale or the 1023 grayscale and thus increasing the number of switching points of the switches SW1a to SW4a accordingly.

### Third Exemplary Embodiment

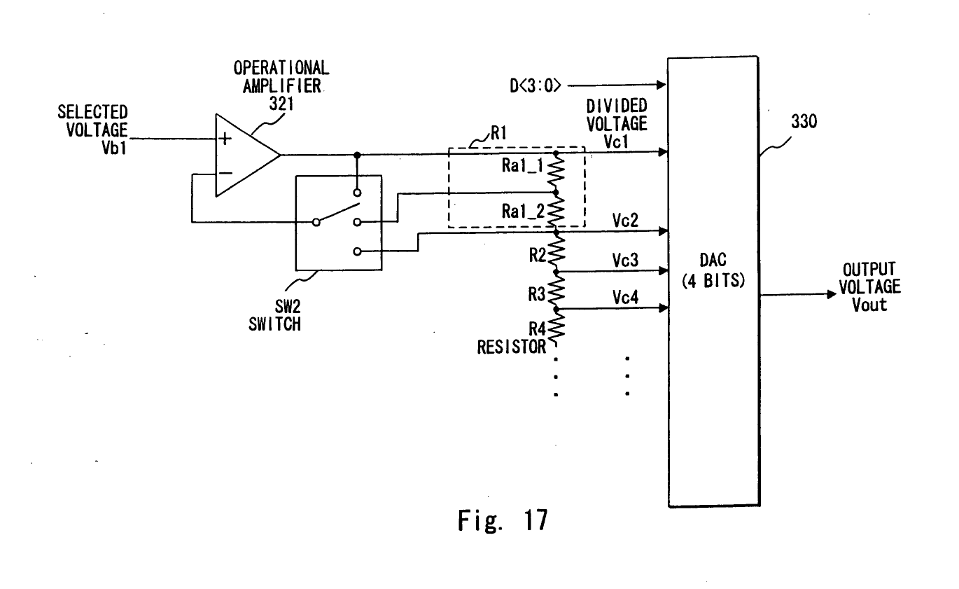

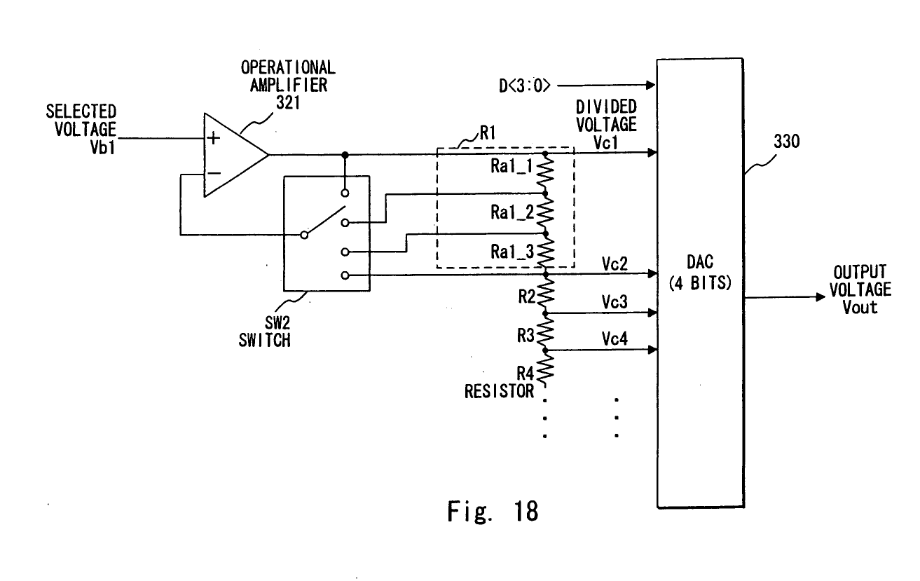

FIG. 17 shows a part of the elements of the signal voltage generation circuit 300 shown in FIG. 2. However, in this exemplary embodiment, the resistor R1 is formed from two resistors for adjustment Ra1_1 and Ra1_2 connected in series. To cope with this modification, the switch SW2 is configured to be able to connect the output terminal of the operational amplifier 321, the connection point between the resistors for adjustment Ra1_1 and Ra1_2, or the connection point between the resistors R1 and R2 to the inverting input terminal of the operational amplifier 321.

In the switch SW2 (or its control unit (not shown)), it is determined in advance that, when the γ-correction voltage Va1 corresponding to 1 grayscale is selected as the selected voltage Vb1, which of the connection point between the resistors for adjustment Ra1_1 and Ra1_2 or the connection point between the resistors R1 and R2 should be selected.

Further, as shown in FIG. 18, the resistor R1 may be formed from three resistors for adjustment Ra1_1 to Ra1_3 so that the switch SW2 can connect the output terminal of the operational amplifier 321, the connection point between the resistors for adjustment Ra1_1 and Ra1_2, the connection point between the resistors for adjustment Ra1_2 and Ra1_3, or the connection point between the resistors R1 and R2 to the inverting input terminal of the operational amplifier 321. That is, a plurality of resistors for adjustment may be provided and the number of switching points of the switch SW2 may be increased.

In this way, fine adjustments can be made to the voltage value of the divided voltage Vc2, and therefore it becomes easier to conform the output voltage characteristics to the γ curve.

Note that it is also possible to increase the number of switching points of the switch SW4 by forming the resistor R15 shown in FIG. 2 with a plurality of resistors for adjustment. In this case, fine adjustments can be made to the voltage value of the divided voltage Vc15, and therefore, likewise, it becomes easier to conform the output voltage characteristics to the γ curve.

Further, by using a similar manner, each of the resistors R1, R2, R14 and R15 shown in FIG. 12 may be formed with a plurality of resistors for adjustment and the number of switching points of each of the switches SW2a and SW4a may be increased, so that fine adjustments can be made to the voltage value of each of the divided voltages Vc2, Vc3, Vc14 and Vc15.

The first to third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

1. A signal voltage generation circuit comprising:
a first voltage selection unit that selects, based on a grayscale value represented by n-bit grayscale data, two γ-correction voltages from among a plurality of γ-correction voltages generated from one reference voltage as γ-correction voltages for higher-order m bits of the grayscale data;
a divided voltage generation unit that generates first to 2^{k}th divided voltages (k=n−m) by dividing a voltage difference between the selected two γ-correction voltages into 2^{k} equal parts; and
a second voltage selection unit that selects one divided voltage from among the first to 2^{k}th divided voltages based on lower-order k bits of the grayscale data,
wherein the first voltage selection unit selects the two γ-correction voltages from among, at least, a γ-correction voltage corresponding to a grayscale value for every 2^{k} grayscale levels including a minimum grayscale value that is represented by the grayscale data, a first γ-correction voltage corresponding to a grayscale value larger than the minimum grayscale value by one, a γ-correction voltage corresponding to a maximum grayscale value that is represented by the grayscale data, and a second γ-correction voltage corresponding to a grayscale value smaller than the maximum grayscale value by one, and
the divided voltage generation unit makes a voltage value of the first divided voltage a voltage value of the γ-correction voltage corresponding to the minimum grayscale value when the γ-correction voltage corresponding to the minimum grayscale value is selected, makes a voltage value of the second divided voltage a voltage value of the first γ-correction voltage when the first γ-correction voltage is selected, makes a voltage value of the (2^{k}−1)th divided voltage a voltage value of the second γ-correction voltage when the second γ-correction voltage is selected, and makes a voltage value of the 2^{k}th divided voltage a voltage value of the γ-correction voltage corresponding to the maximum grayscale value when the γ-correction voltage corresponding to the maximum grayscale value is selected.

2. The signal voltage generation circuit according to claim 1,
wherein the divided voltage generation unit comprising:
first and second operational amplifiers, the selected two γ-correction voltages being respectively input to non-inverting input terminals of the first and second operational amplifiers;
first to 2^{k}th resistors connected in series between output terminals of the first and second operational amplifiers, first to 2^{k}th resistors having a same resistance value as each other;
a first switch circuit that connects an output terminal of the first operational amplifier or a connection point between the first and second resistors to an inverting input terminal of the first operational amplifier; and
a second switch circuit that connects an output terminal of the second operational amplifier, a connection point between the 2^{k}th and (2^{k}−1)th resistors, or a connection point between the (2^{k}−1)th and (2^{k}−2)th resistors to an inverting input terminal of the second operational amplifier, and
the divided voltages are generated at the output terminal of the first operational amplifier and at a connection point between neighboring resistors.

3. The signal voltage generation circuit according to claim 1, wherein the first voltage selection unit comprising:
a third voltage selection unit that receives the γ-correction voltage corresponding to the grayscale value for every 2^{k} grayscale levels and the γ-correction voltage corresponding to the maximum grayscale value, and selects the two γ-correction voltages from among the received γ-correction voltages based on higher-order m bits of the grayscale data;
a switch circuit that outputs the γ-correction voltage corresponding to the minimum grayscale value or the first γ-correction voltage to the third voltage selection unit as the γ-correction voltage corresponding to the minimum grayscale value; and
a switch circuit that outputs the γ-correction voltage corresponding to the maximum grayscale value or the second γ-correction voltage to the third voltage selection unit as the γ-correction voltage corresponding to the maximum grayscale value.

4. The signal voltage generation circuit according to claim 2,
wherein the first resistor comprises a plurality of resistors for adjustment connected in series, and
it is determined in advance that, when the first γ-correction voltage is selected, which of connection points of the resistors for adjustment or the connection point between the first and second resistors is selected by the first switch circuit.

5. The signal voltage generation circuit according to claim 2,
wherein the (2^{k}−1)th resistor comprises a plurality of resistors for adjustment connected in series, and
it is determined in advance that, when the second γ-correction voltage is selected, which of connection points of the resistors for adjustment or the connection point between the (2^{k}−1)th and the (2^{k}−2)th resistors is selected by the second switch circuit.

6. The signal voltage generation circuit according to claim 1,
wherein the first voltage selection unit further includes a third γ-correction voltage corresponding to a grayscale value larger than the minimum grayscale value by two and a fourth γ-correction voltage corresponding to a grayscale value smaller than the maximum grayscale value by two in selection candidates for the two γ-correction voltages, and
the divided voltage generation unit further make a voltage value of the third divided voltage a voltage of the third γ-correction voltage when the third γ-correction voltage is selected, and makes a voltage value of the (2^{k}−2)th divided voltage a voltage of the fourth γ-correction voltage when the fourth γ-correction voltage is selected.

7. The signal voltage generation circuit according to claim 6,
wherein the divided voltage generation unit comprising:
first and second operational amplifiers, the selected two γ-correction voltages being respectively input to non-inverting input terminals of the first and second operational amplifiers;
first to 2^{k}th resistors connected in series between output terminals of the first and second operational amplifiers, first to 2^{k}th resistors having a same resistance value as each other;
a first switch circuit that connects an output terminal of the first operational amplifier, a connection point between the first and second resistors, or a connection point between the second and third resistors to an inverting input terminal of the first operational amplifier; and
a second switch circuit that connects an output terminal of the second operational amplifier, a connection point between the 2^{k}th and (2^{k}−1)th resistors, a connection point between the (2^{k}−1)th and (2^{k}−2)th resistors, or a connection point between the (2^{k}−2)th and (2^{k}−3)th resistors to an inverting input terminal of the second operational amplifier, and
the divided voltages are generated at the output terminal of the first operational amplifier and at a connection point between neighboring resistors.

8. The signal voltage generation circuit according to claim 6, wherein the first voltage selection unit comprising:
a third voltage selection unit that receives the γ-correction voltage corresponding to the grayscale value for every 2^{k} grayscale levels and the γ-correction voltage corresponding to the maximum grayscale value, and selects the two γ-correction voltages from among the received γ-correction voltages based on higher-order m bits of the grayscale data;
a switch circuit that outputs the γ-correction voltage corresponding to the minimum grayscale value, the first γ-correction voltage, or the third γ-correction voltage to the third voltage selection unit as the γ-correction voltage corresponding to the minimum grayscale value; and
a switch circuit that outputs the γ-correction voltage corresponding to the maximum grayscale value, the second γ-correction voltage, or the fourth γ-correction voltage to the third voltage selection unit as the γ-correction voltage corresponding to the maximum grayscale value.

9. The signal voltage generation circuit according to claim 7,
wherein each of the first and second resistors comprises a plurality of resistors for adjustment connected in series, and
it is determined in advance that, when the first γ-correction voltage is selected, which of connection points of the resistors for adjustment included in the first resistor or the connection point between the first and second resistors is selected by the first switch circuit, and that when the third γ-correction voltage is selected, which of connection points of the resistors for adjustment included in the second resistor or the connection point between the second and third resistors is selected by the first switch circuit.

10. The signal voltage generation circuit according to claim 7,
wherein each of the (2^{k}−1)th and (2^{k}−2)th resistors comprises a plurality of resistors for adjustment connected in series, and
it is determined in advance that, when the second γ-correction voltage is selected, which of connection points of the resistors for adjustment included in the (2^{k}−1)th resistor or the connection point between the (2^{k}−1)th and (2^{k}−2)th resistors is selected by the second switch circuit, and that when the fourth γ-correction voltage is selected, which of connection points of the resistors for adjustment included in the (2^{k}−2)th resistor or the connection point between the (2^{k}−2)th and (2^{k}−3)th resistors is selected by the second switch circuit.

11. The signal voltage generation circuit according to claim 2, further comprising a control unit that controls each switch circuit based on the grayscale value represented by the grayscale data.

12. A display panel driving device comprising:
a data shaping circuit that shapes input data into n-bit grayscale data;
a γ-correction voltage generation circuit that generates, at least, a γ-correction voltages corresponding to a grayscale value for every 2^{k} grayscale levels (k=n−m) including a minimum grayscale value that is represented by the grayscale data, a first γ-correction voltage corresponding to a grayscale value larger than the minimum grayscale value by one, a γ-correction voltage corresponding to a maximum grayscale value that is represented by the grayscale data, and a second γ-correction voltage corresponding to a grayscale value smaller than the maximum grayscale value by one from one reference voltage; and
a signal voltage generation circuit including a first voltage selection unit that selects two γ-correction voltages from among the γ-correction voltages as γ-correction voltages for higher-order m bits of the grayscale data based on a grayscale value represented by the grayscale data, a divided voltage generation unit that generates first to 2^{k}th divided voltages by dividing a voltage difference between the selected two γ-correction voltages into 2^{k} equal parts, and a second voltage selection unit that selects one divided voltage from among the first to 2^{k}th divided voltages based on lower-order k bits of the grayscale data,
wherein the divided voltage generation unit makes a voltage value of the first divided voltage a voltage value of the γ-correction voltage corresponding to the minimum grayscale value when the γ-correction voltage corresponding to the minimum grayscale value is selected, makes a voltage value of the second divided voltage a voltage value of the first γ-correction voltage when the first γ-correction voltage is selected, makes a voltage value of the (2^{k}−1)th divided voltage a voltage value of the second γ-correction voltage when the second γ-correction voltage is selected, and makes a voltage value of the 2^{k}th divided voltage a voltage value of the γ-correction voltage corresponding to the maximum grayscale value when the γ-correction voltage corresponding to the minimum maximum grayscale value is selected.

13. The display panel driving device according to claim 12,
wherein the γ-correction voltage generation unit further generates a third γ-correction voltage corresponding to a grayscale value larger than the minimum grayscale value by two and a fourth γ-correction voltage corresponding to a grayscale value smaller than the maximum grayscale value by two from the one reference voltage,
the first voltage selection unit further includes the third and fourth γ-correction voltages in selection candidates for the two γ-correction voltages, and
the divided voltage generation unit further makes a voltage value of the third divided voltage a voltage of the third γ-correction voltage when the third γ-correction voltage is selected, and makes a voltage value of the (2^{k}−2)th divided voltage a voltage of the fourth γ-correction voltage when the fourth γ-correction voltage is selected.

14. A display apparatus comprising:
the display panel driving device according to claim 12; and
a display panel driven by the display panel driving device.
